(19) United States
(12) Patent Application Publication
(10) Pub. No.: US 2014/0254664 A1
(43) Pub. Date: Sep. 11, 2014

(54) METHODS TO PERFORM INTRA PREDICTION FOR COMPRESSION OF CFA DATA

(71) Applicant: SONY CORPORATION, Tokyo (JP)

(72) Inventors: Wei Liu, San Jose, CA (US); Mohammad Gharavi-Alkhansari, San Jose, CA (US)

(21) Appl. No.: 13/793,002

(22) Filed: Mar. 11, 2013

(51) Int. Cl. H04N 7/34

(52) U.S. Cl. CPC H04N 19/00763
USPC 375/240.12

(57) ABSTRACT

Methods to perform intra prediction for compression of color filter array data utilize one or more prediction patterns and two lines of memory to support more than one color filter array and to improve performance.

### FIELD OF THE INVENTION

The present invention relates to the field of image processing. More specifically, the present invention relates to intra prediction for compression.

### BACKGROUND OF THE INVENTION

Many image compression systems rely heavily on prediction method. The performance of such systems depends largely on the quality of the prediction technique.

### SUMMARY OF THE INVENTION

Methods to perform intra prediction for compression of color filter array data utilize one or more prediction patterns and two lines of memory to support more than one color filter array and to improve performance.

In one aspect, a method of intra prediction for compression programmed in a controller of a device comprises partitioning an image into one or more blocks and encoding the one or more blocks using a plurality of prediction patterns. In each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position. The method further comprises determining a color filter array used in acquiring the image. The color filter array is a Bayer filter, a Wichi filter or a Complementary filter. The plurality of prediction patterns is selected based on the determined color filter array. Encoding the one or more blocks includes computing prediction values for each pixel in a block of the one or more blocks using one or more prediction modes. The prediction modes include at least one of: DC, RightRightUp, RightUp, RightUpUp, Up, LeftUpUp, LeftUp, LeftLeftUp and Left. When prediction from pixels located in the same row but at the left of a current block is not possible, a left pixel in a block of the one or more blocks uses a modified left prediction mode. When a block of the one or more blocks is on a boundary of the image, boundary pixels are extended by copying the block to fit the plurality of prediction patterns. The device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

In another aspect, a system for image compression programmed in a controller in a device comprises a partitioning module configured for partitioning an image into one or more blocks and an encoding module configured for encoding the one or more blocks using a plurality of prediction patterns. In each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position. The system further comprises a determining module configured for determining a color filter array used in acquiring the image. The color filter array is a Bayer filter, a Wichi filter or a Complementary filter. The plurality of prediction patterns is selected based on the determined color filter array. Encoding the one or more blocks includes computing prediction values for each pixel in a block of the one or more blocks using one or more prediction modes. The prediction modes include at least one of: DC, RightRightUp, RightUp, RightUpUp, Up, LeftUpUp, LeftUp, LeftLeftUp and Left. When prediction from pixels located in the same row but at the left of a current block is not possible, a left pixel in a block of the one or more blocks uses a modified left prediction mode. When a block of the one or more blocks is on a boundary of the image, boundary pixels are extended by copying the block to fit the plurality of prediction patterns. The device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

In another aspect, a camera device comprises a video acquisition component for acquiring a video, a memory for storing an application, the application for partitioning an image into one or more blocks and encoding the one or more blocks using a plurality of prediction patterns and a processing component coupled to the memory, the processing component configured for processing the application. In each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position. The application is further for determining a color filter array used in acquiring the image. The color filter array is a Bayer filter, a Wichi filter or a Complementary filter. The plurality of prediction patterns is selected based on the determined color filter array. Encoding the one or more blocks includes computing prediction values for each pixel in a block of the one or more blocks using one or more prediction modes. The prediction modes include at least one of: DC, RightRightUp, RightUp, RightUpUp, Up, LeftUpUp, LeftUp, LeftLeftUp and Left. When prediction from pixels located in the same row but at the left of a current block is not possible, a left pixel in a block of the one or more blocks uses a modified left prediction mode. Wherein when a block of the one or more blocks is on a boundary of the image, boundary pixels are extended by copying the block to fit the plurality of prediction patterns.

### BRIEF DESCRIPTION OF THE DRAWINGS

FIG. 1 illustrates diagrams of color filter arrays according to some embodiments.

FIG. 2 illustrates a summary of mapping pixels to prediction patterns according to some embodiments.

FIG. 3 illustrates prediction pattern A according to some embodiments.

FIG. 4 illustrates prediction pattern B according to some embodiments.

FIG. 5 illustrates prediction pattern C according to some embodiments.

FIG. 6 illustrates prediction pattern D according to some embodiments.

FIG. 7 illustrates prediction pattern E according to some embodiments.

FIG. 8 illustrates determining the left pixel for each of the prediction patterns without using pixels in the left block according to some embodiments.

FIG. 9 illustrates an extension for a Bayer CFA according to some embodiments.

FIG. 10 illustrates an extension for a Wichi CFA according to some embodiments.

FIG. 11 illustrates an extension for a Complementary CFA according to some embodiments.

FIG. 12 illustrates a diagram of prediction combinations according to some embodiments.

FIG. 13 illustrates a flowchart of a method of performing intra prediction for compression of CFA data according to some embodiments.

FIG. 14 illustrates a block diagram of an exemplary computing device configured to implement the intra prediction for compression of CFA data method according to some embodiments.

### DETAILED DESCRIPTION OF THE PREFERRED EMBODIMENT

An image Coder-Decoder (“codec”) for camera sensors utilizes predictions methods supporting Color Filter Arrays (CFAs) such as Bayer, Wichi and Complementary. The methods use two lines of memory to improve prediction performance.

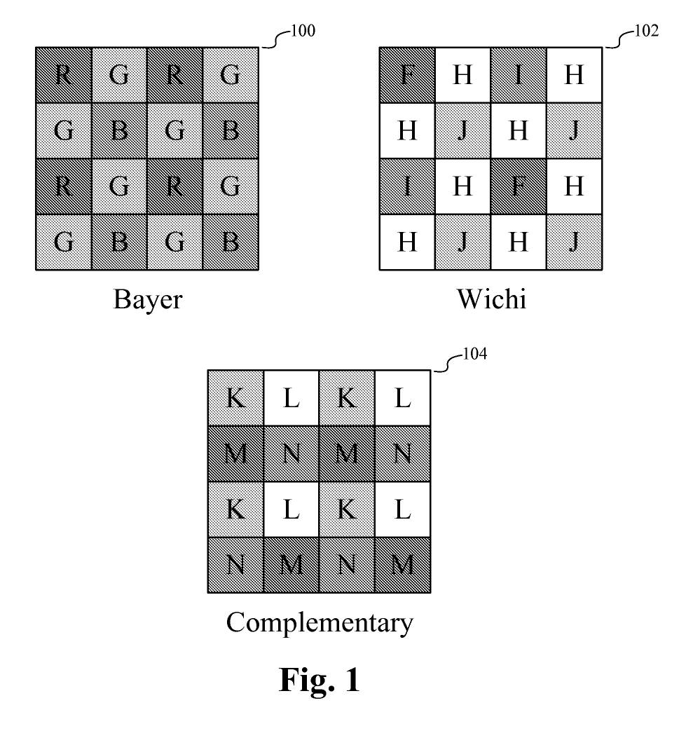

FIG. 1 illustrates diagrams of color filter arrays according to some embodiments. A Bayer CFA 100 includes a pattern that is made up of 3 different color components R, G, and B. A Wichi CFA 102 includes a pattern that is made up of 4 different color components F, H, I, and J. A Complementary CFA 104 is made up of 4 different color components K, L, M, and N.

The prediction modes include DC, RightRightUp, RightUp, RightUpUp, Up, LeftUpUp, LeftUp, LeftLeftUp and Left.

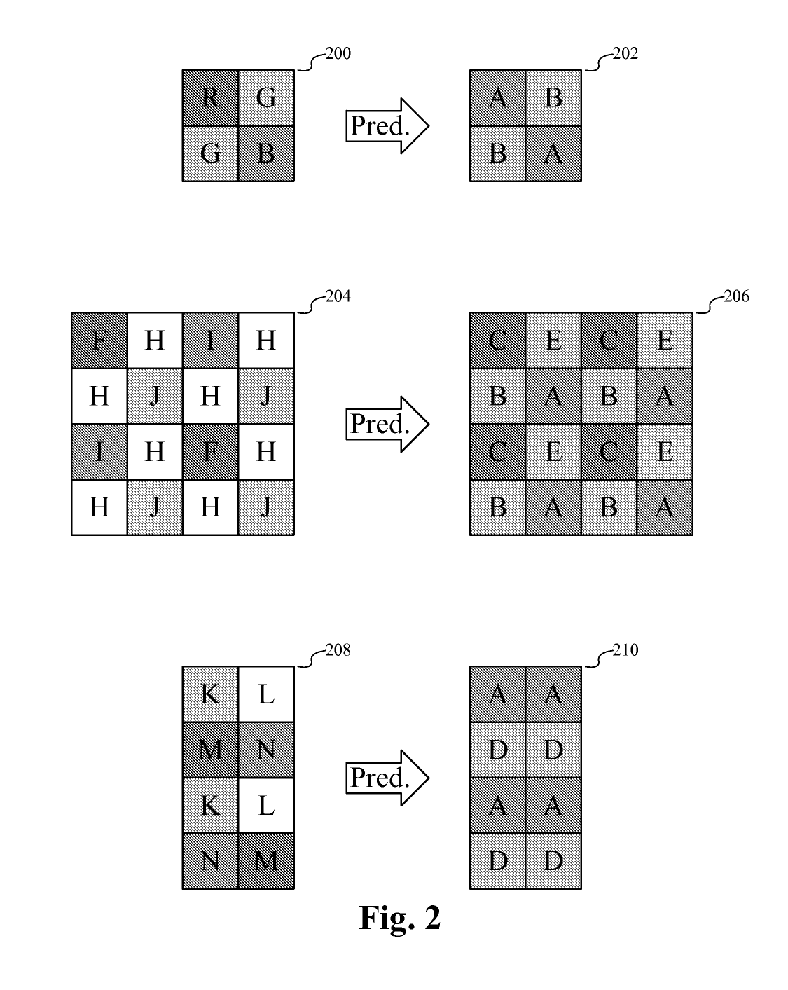

FIG. 2 illustrates a summary of mapping pixels to prediction patterns according to some embodiments. A segment of a Bayer CFA 200 is mapped to a prediction pattern 202 including patterns A and B, where pattern A is used for predicting R and B components, and pattern B is used for predicting the G component. A Wichi CFA 204 is mapped to a prediction pattern 206 including patterns A, B, C and E, where pattern A is used for predicting J, pattern B is used for predicting H in the H-J lines, pattern C is used for predicting F and I, and pattern E is used for predicting H in the F-H-I-H lines. A segment of a Complementary CFA 208 is mapped to a prediction pattern 210 including patterns A and D, wherein pattern A is used for predicting K and L, and pattern D is used for predicting M and N.

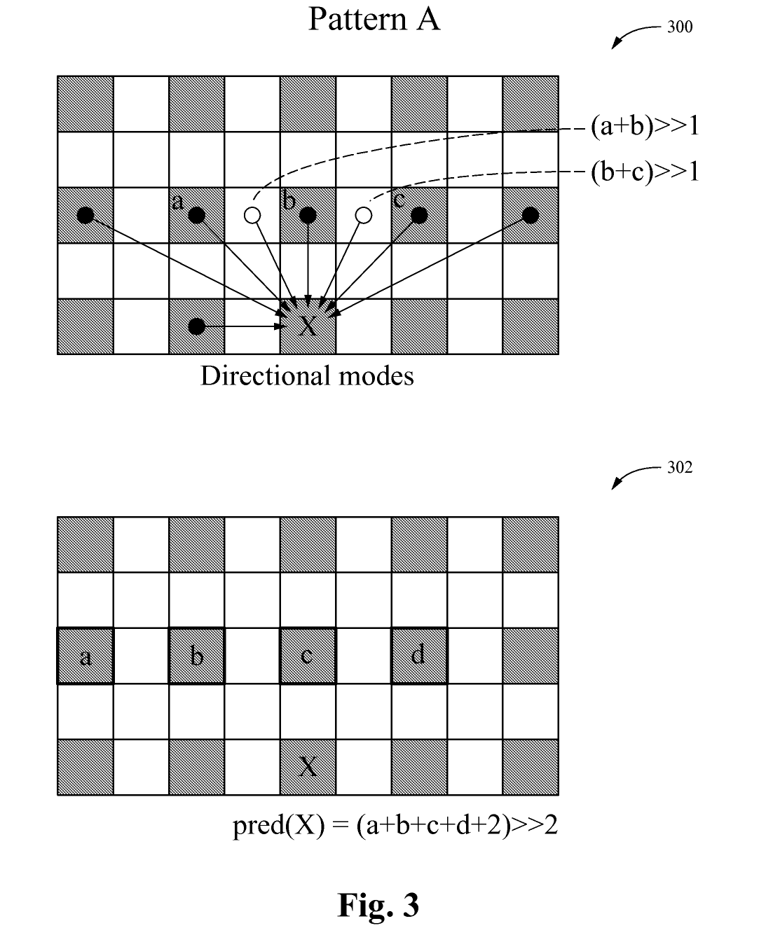

FIG. 3 illustrates prediction pattern A according to some embodiments. The prediction pattern A is used for R and B of Bayer, J of Wichi and K and L of Complementary. The various directional modes are able to be used to predict pixel X as shown in 300. The Left prediction uses a pixel two positions to the left of pixel X. The LeftLeftUp prediction uses a pixel four positions to the left and two positions up. The LeftUp prediction uses a pixel two positions to the left and two positions up. The LeftUpUp prediction uses a pixel one position to the left and two positions up. The Up prediction uses a pixel two positions up. The RightUpUp prediction uses a pixel one position to the right and two positions up. The RightUp prediction uses a pixel two positions to the right and two positions up. The RightRightUp prediction uses a pixel four positions to the right and two positions up. The DC mode prediction uses the average of the four pixels (a, b, c, d) shown in 302.

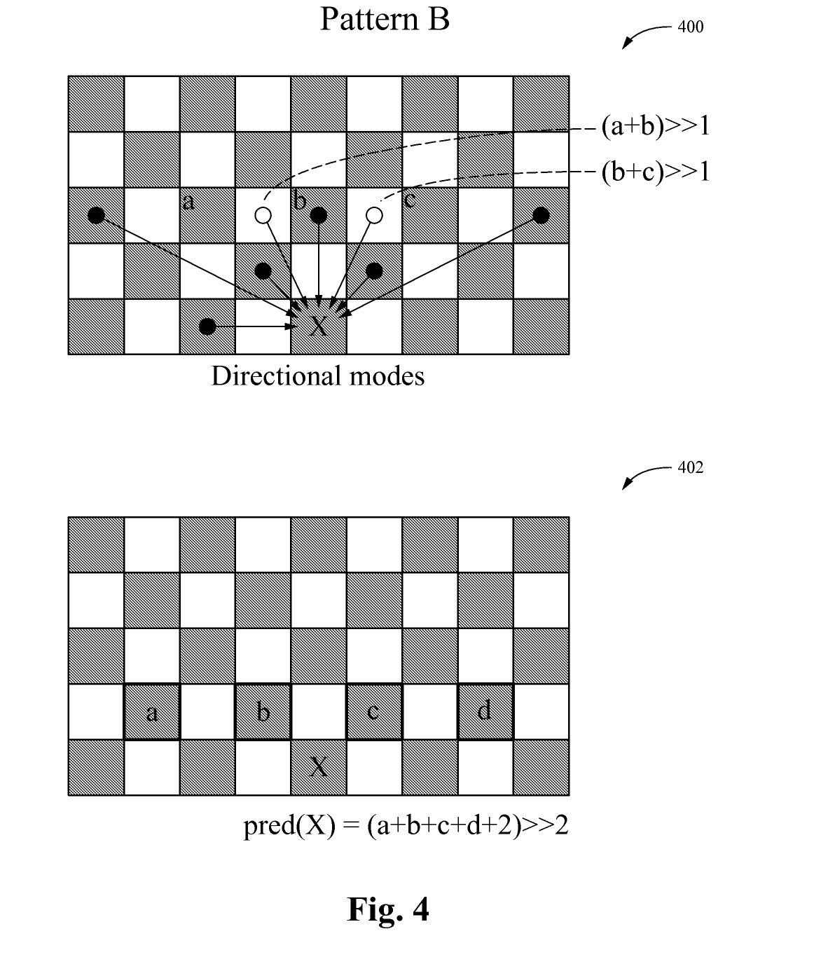

FIG. 4 illustrates prediction pattern B according to some embodiments. The prediction pattern B is used for G of Bayer and H in the H-J lines of Wichi. The various directional modes are able to be used to predict pixel X as shown in 400. The Left prediction uses a pixel two positions to the left of pixel X. The LeftLeftUp prediction uses a pixel four positions to the left and two positions up. The LeftUp prediction uses a pixel one position to the left and one position up. The LeftUpUp prediction uses a pixel one position to the left and two positions up. The Up prediction uses a pixel two positions up. The RightUpUp prediction uses a pixel one position to the right and two positions up. The RightUp prediction uses a pixel one position to the right and one position up. The RightRightUp prediction uses a pixel four positions to the right and two positions up. The DC mode prediction uses the average of the four pixels (a, b, c, d) shown in 402.

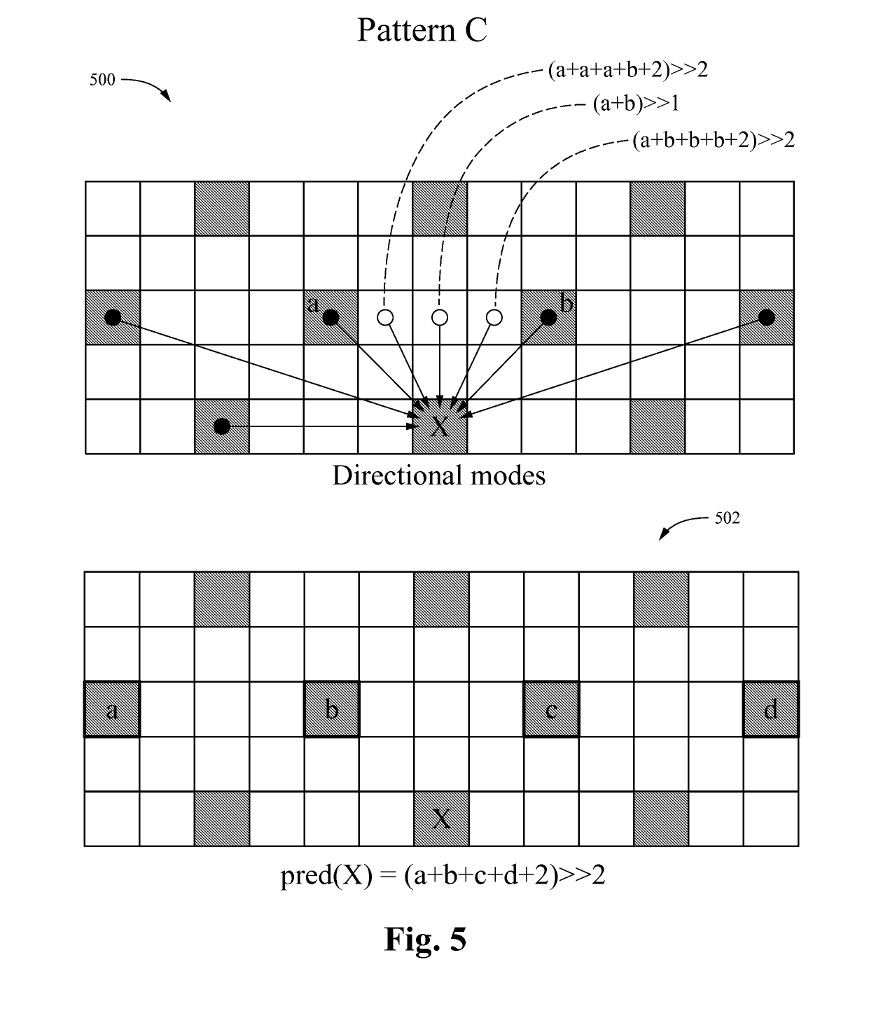

FIG. 5 illustrates prediction pattern C according to some embodiments. The prediction pattern C is used for F and I of Wichi. The various directional modes are able to be used to predict pixel X as shown in 500. The Left prediction uses a pixel four positions to the left of pixel X. The LeftLeftUp prediction uses a pixel six positions to the left and two positions up. The LeftUp prediction uses a pixel two positions to the left and two positions up. The LeftUpUp prediction uses a pixel one position to the left and two positions up. The Up prediction uses a pixel two positions up. The RightUpUp prediction uses a pixel one position to the right and two positions up. The RightUp prediction uses a pixel two positions to the right and two positions up. The RightRightUp prediction uses a pixel six positions to the right and two positions up. The DC mode prediction uses the average of the four pixels (a, b, c, d) shown in 502.

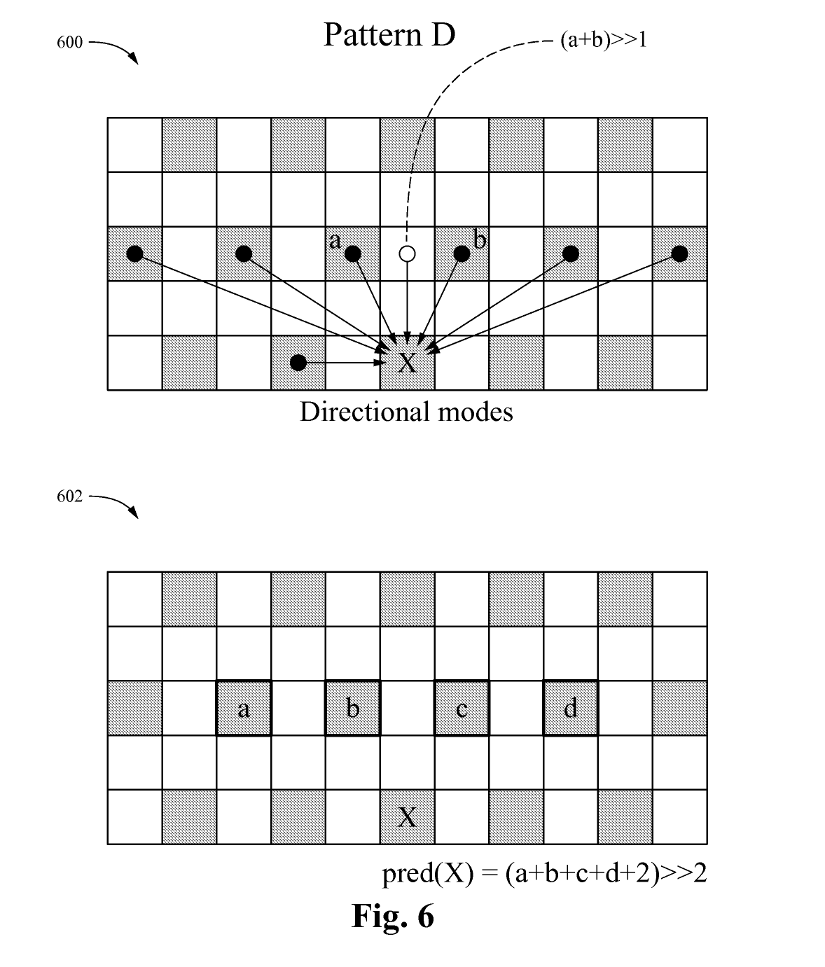

FIG. 6 illustrates prediction pattern D according to some embodiments. The prediction pattern D is used for M and N of Complementary. The various directional modes are able to be used to predict pixel X as shown in 600. The Left prediction uses a pixel two positions to the left of pixel X. The LeftLeftUp prediction uses a pixel five positions to the left and two positions up. The LeftUp prediction uses a pixel three positions to the left and two positions up. The LeftUpUp prediction uses a pixel one position to the left and two positions up. The Up prediction uses a pixel two positions up. The RightUpUp prediction uses a pixel one position to the right and two positions up. The RightUp prediction uses a pixel three positions to the right and two positions up. The RightRightUp prediction uses a pixel five positions to the right and two positions up. The DC mode prediction uses the average of the four pixels (a, b, c, d) shown in 602.

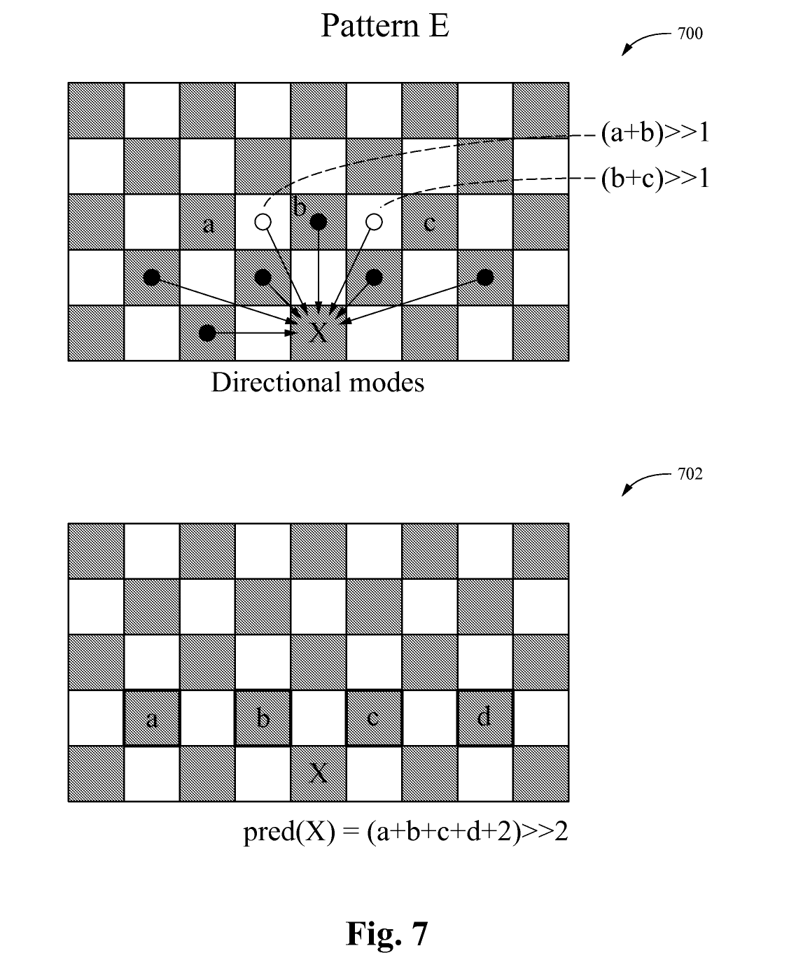

FIG. 7 illustrates prediction pattern E according to some embodiments. The prediction pattern E is used for H in the F-H-I-H lines of Wichi. The various directional modes are able to be used to predict pixel X as shown in 700. The Left prediction uses a pixel two positions to the left of pixel X. The LeftLeftUp prediction uses a pixel four positions to the left and one position up. The LeftUp prediction uses a pixel one position to the left and one position up. The LeftUpUp prediction uses a pixel one position to the left and two positions up. The Up prediction uses a pixel two positions up. The RightUpUp prediction uses a pixel one position to the right and two positions up. The RightUp prediction uses a pixel one position to the right and one position up. The RightRightUp prediction uses a pixel three positions to the right and one position up. The DC mode prediction uses the average of the four pixels (a, b, c, d) shown in 702.

In the predicted patterns, in some embodiments, it is assumed that for the prediction of the current block, the pixels in the left block are not used. The coding of neighboring blocks is independent of each other and is helpful for hardware parallelization. Therefore, for the left pixel in the current block, only in the ‘Left’ prediction mode, the prediction is modified such that the prediction does not use the left block.

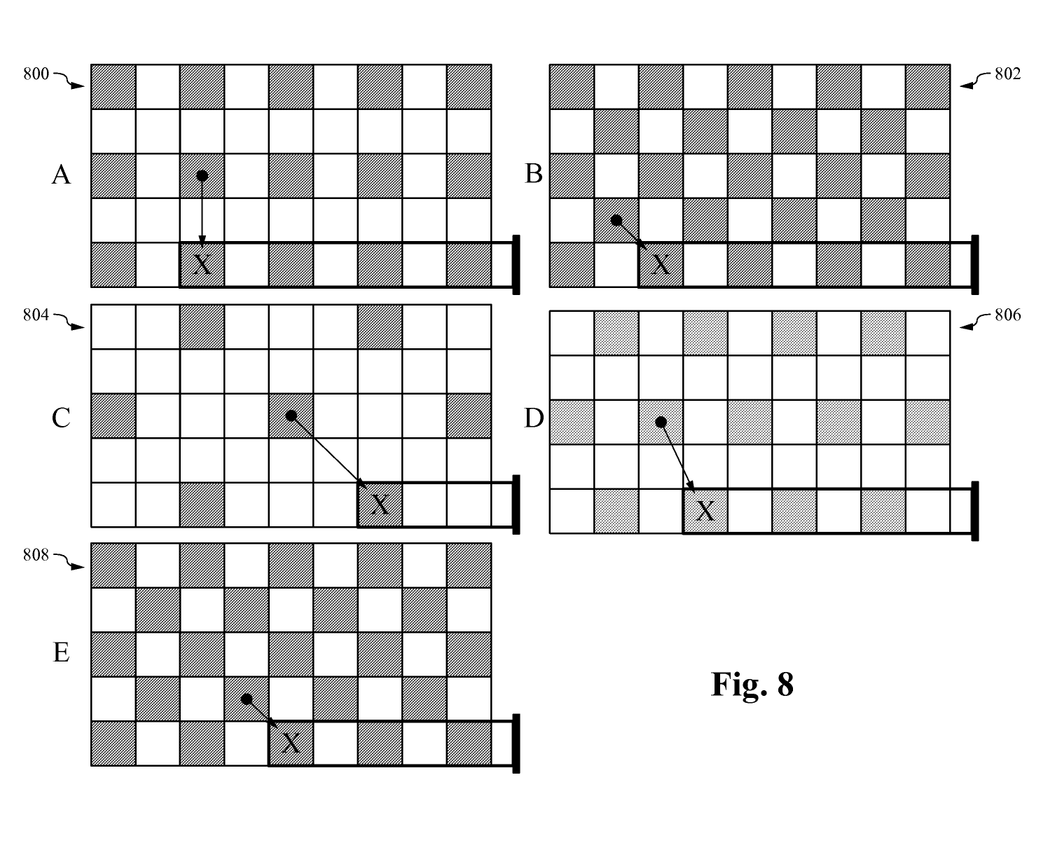

FIG. 8 illustrates determining the left pixel for each of the prediction patterns without using pixels in the left block according to some embodiments. For pattern A 800, a pixel two positions up is used for the Left prediction. For pattern B 802, a pixel one position left and one position up is used for the Left prediction. For pattern C 804, a pixel two positions left and two positions up is used for the Left prediction. For pattern D 806, a pixel one position left and two positions up is used for the Left prediction. For pattern E 808, a pixel one position left and one position up is used for the Left prediction.

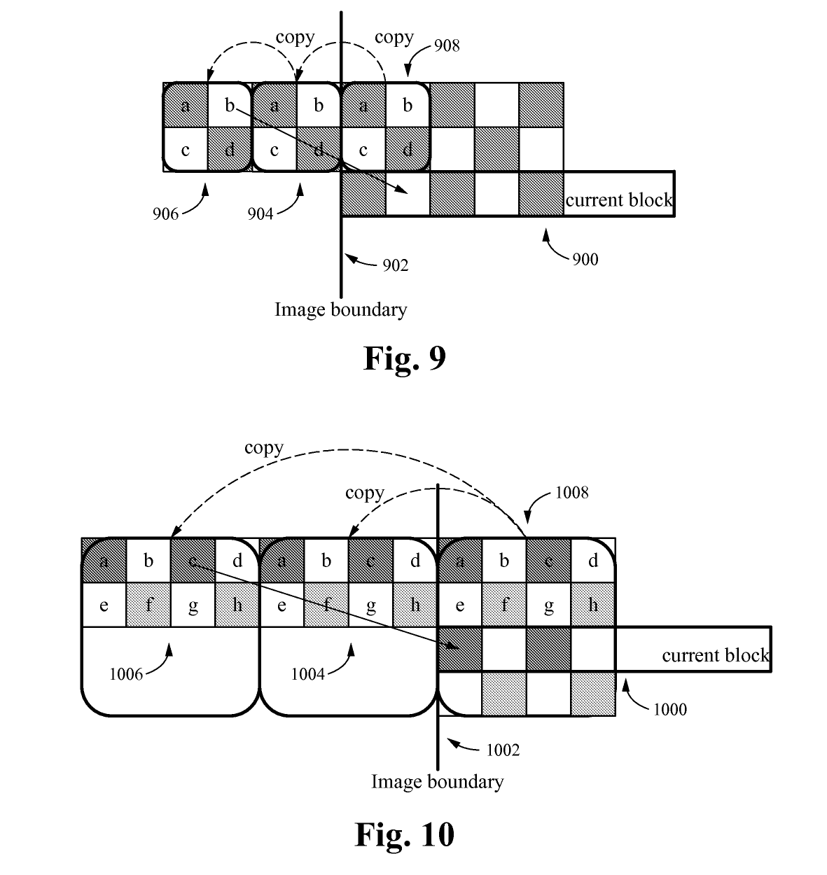

When a block is on the boundary of an image, some neighboring pixels are not available for prediction. The boundary pixels are extended by copying to fit in the prediction patterns. Examples of the extension on the left-hand side of an image are shown in FIGS. 9-11. Right extension is similar to left extension.

FIG. 9 illustrates an extension for a Bayer CFA according to some embodiments. A current block 900 is shown with a lefthand boundary 902. To utilize the pixel four positions to the left and two positions up, a first copy 904 and a second copy 906 are made of a portion of the block 908, so that a pixel is in the correct position to use for prediction.

FIG. 10 illustrates an extension for a Wichi CFA according to some embodiments. A current block 1000 is shown with a lefthand boundary 1002. To utilize the pixel six positions to the left and two positions up, a first copy 1004 and a second copy 1006 are made of a portion of the block 1008, so that a pixel is in the correct position to use for prediction.

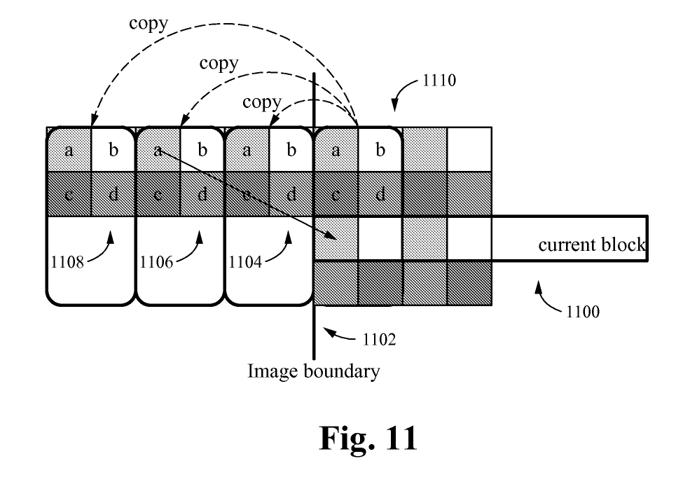

FIG. 11 illustrates an extension for a Complementary CFA according to some embodiments. A current block 1100 is shown with a lefthand boundary 1102. To utilize the pixel six positions to the left and two positions up, a first copy 1104, a second copy 1106 and a third copy 1108 are made of a portion of the block 1110, so that a pixel is in the correct position to use for prediction.

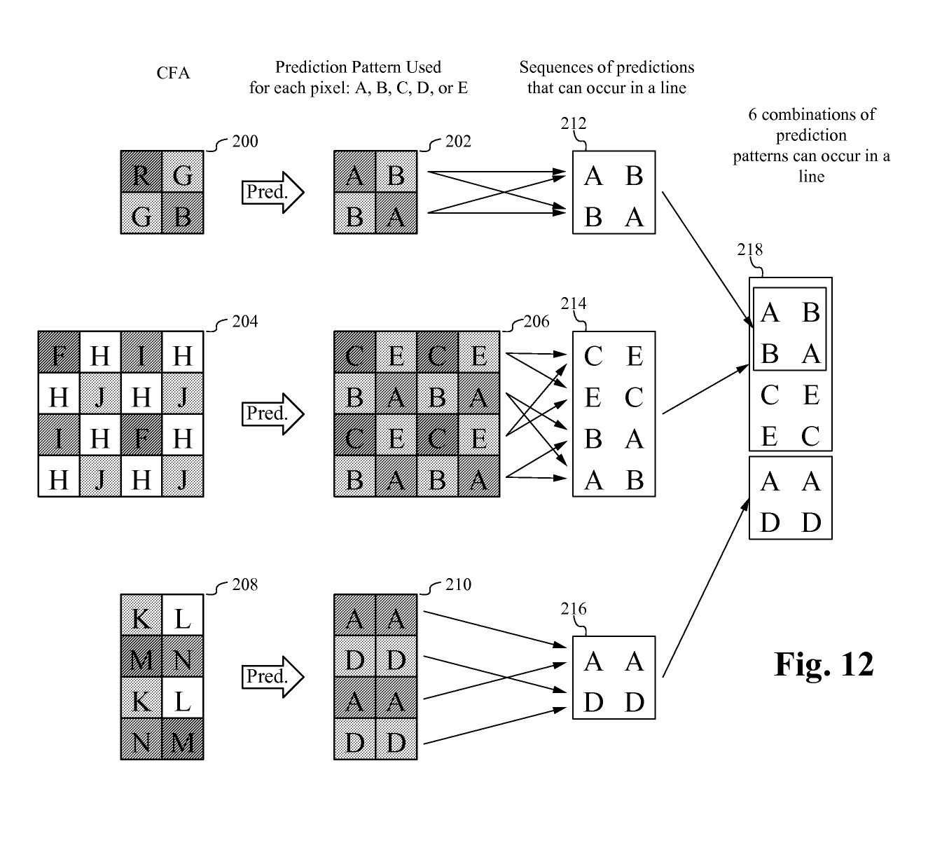

FIG. 12 illustrates a diagram of prediction combinations according to some embodiments. A segment of a Bayer CFA 200 is mapped to a prediction pattern 202 including patterns A and B, where pattern A is used for predicting R and B, and pattern B is used for predicting G. A Wichi CFA 204 is mapped to a prediction pattern 206 including patterns A, B, C and E, where pattern A is used for predicting J, pattern B is used for predicting the H in the H-J lines, pattern C is used for predicting F and I, and pattern E is used for predicting H in the F-H-I-H lines. A segment of a Complementary CFA 208 is mapped to a prediction pattern 210 including patterns A and D, wherein pattern A is used for predicting K and L, and pattern D is used for predicting M and N.

The sequences of predications that are able to occur in a line are shown. For example, in the prediction pattern for the Bayer CFA, the sequences 212 are AB and BA. In the prediction pattern for the Wichi CFA, the sequences 214 are CE, EC, BA and AB. In the prediction pattern for the Complementary CFA, the sequences 216 are AA and DD. Therefore, there are 6 combinations of prediction patterns 218 that are able to occur in a line: AB, BA, CE, EC, AA and DD.

In enhanced bit coding, a block of data is encoded together. The block usually has a height of 1. For sensor data, a block usually contains multiple colors. Therefore, more than 1 prediction pattern is used in a block, but the same prediction mode is used. For example, in the RG line of Bayer data, prediction pattern A and pattern B are used in the same block.

The prediction patterns are defined such that the 8 directions in patterns A and B are parallel to each other, and the 8 directions in patterns C and E are parallel to each other, because prediction patterns A and C are able to occur in the same block, and prediction patterns C and E occur in the same block.

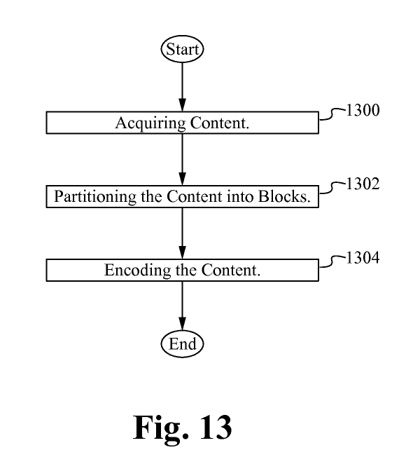

FIG. 13 illustrates a flowchart of a method of performing intra prediction for compression of CFA data according to some embodiments. In the step 1300, content (e.g., an image or a video) is acquired. In some embodiments, the content is CFA data. The CFA data is able to be from a Bayer CFA, a Wichi CFA, a Complementary CFA and/or another CFA. In the step 1302, the content is partitioned into blocks. In the step 1304, the content is encoded using one or more prediction patterns. In each block, for the purpose of compression, all the pixels in the block use one of nine possible prediction patterns. The prediction pattern is the same for all the pixels in one block, but is able to change from block to another by proper signaling. In each block, the order of processing of the pixels is in raster scan order, from left to right, and from top to bottom. Prediction for each color component is performed using samples only from the same color component but at a different position. In some embodiments, fewer or additional steps are implemented. For example, the Left prediction is implemented using a modified prediction scheme. In another example, for blocks at an image boundary, portions of the image are copied to perform predictions. In some embodiments, it is determined which CFA is used, and then the prediction pattern(s) are selected based on the CFA. Determining the CFA used is able to be implemented in any manner, for example, receiving bits identifying the CFA. In some embodiments, the order of the steps is able to be modified.

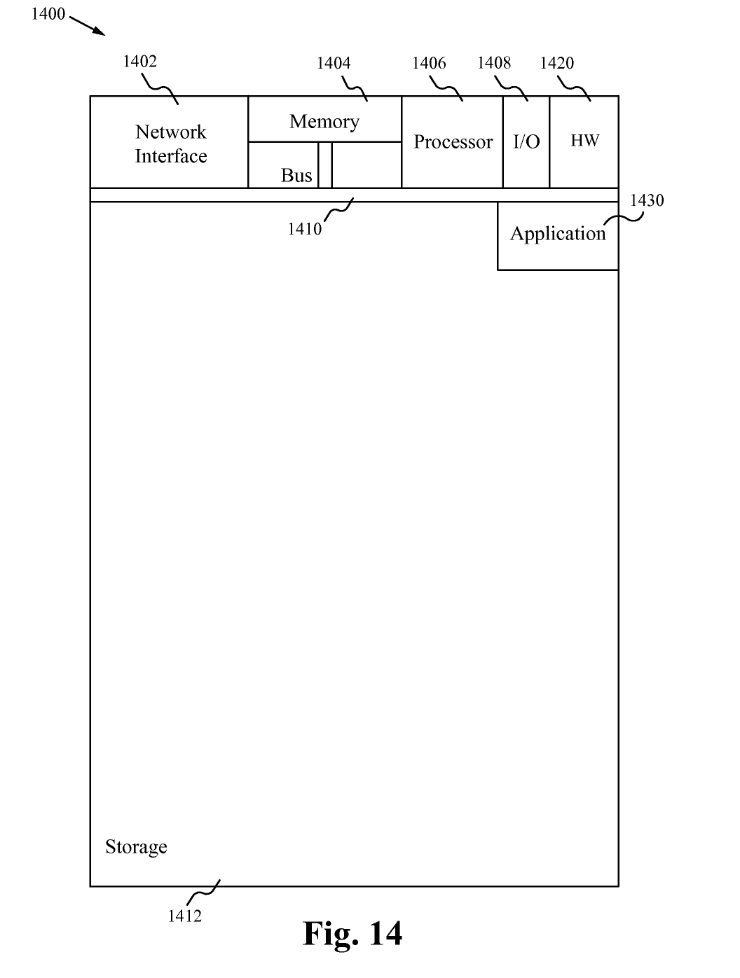

FIG. 14 illustrates a block diagram of an exemplary computing device 1400 configured to implement the intra prediction for compression of CFA data method according to some embodiments. The computing device 1400 is able to be used to acquire, store, compute, communicate and/or display information such as images and videos. For example, a computing device 1400 is able to acquire and store an image. The intra prediction for compression of CFA data method is able to be used when acquiring or viewing an image on the device 1400. In general, a hardware structure suitable for implementing the computing device 1400 includes a network interface 1402, a memory 1404, a processor 1406, I/O device(s) 1408, a bus 1410 and a storage device 1412. The choice of processor is not critical as long as a suitable processor with sufficient speed is chosen. The memory 1404 is able to be any conventional computer memory known in the art. The storage device 1412 is able to include a hard drive, CDROM, CDRW, DVD, DVDRW, flash memory card or any other storage device. The computing device 1400 is able to include one or more network interfaces 1402. An example of a network interface includes a network card connected to an Ethernet or other type of LAN. The I/O device(s) 1408 are able to include one or more of the following: keyboard, mouse, monitor, display, printer, modem, touchscreen, button interface and other devices. Intra prediction for compression of CFA data application(s) 1430 used to perform the intra prediction for compression of CFA data method are likely to be stored in the storage device 1412 and memory 1404 and processed as applications are typically processed. More or less components shown in FIG. 14 are able to be included in the computing device 1400. In some embodiments, intra prediction for compression of CFA data hardware 1420 is included. Although the computing device 1400 in FIG. 14 includes applications 1430 and hardware 1420 for intra prediction for compression of CFA data, the intra prediction for compression of CFA data method is able to be implemented on a computing device in hardware, firmware, software or any combination thereof. For example, in some embodiments, the intra prediction for compression of CFA data applications 1430 are programmed in a memory and executed using a processor. In another example, in some embodiments, the intra prediction for compression of CFA data hardware 1420 is programmed hardware logic including gates specifically designed to implement the image compression method.

In some embodiments, the intra prediction for compression of CFA data application(s) 1430 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

To utilize the intra prediction for compression of CFA data method, a user acquires a video/image such as on a digital camcorder, and while or after the video is acquired, the intra prediction for compression of CFA data method automatically compresses the CFA data. The intra prediction for compression of CFA data method occurs automatically without user involvement.

In operation, the intra prediction for compression of CFA data method described herein provides image compression with a low hardware cost (e.g. not many logic gates are needed) in some embodiments, low complexity, low delay and very high visual quality (e.g. visually lossless). The intra prediction for compression of CFA data method is able to be used in any implementation including, but not limited to, wireless high definition (Wireless HD).

### Some Embodiments of Methods to Perform Intra Prediction for Compression of CFA Data

1. A method of intra prediction for compression programmed in a controller of a device comprising:
   a. partitioning an image into one or more blocks; and
   b. encoding the one or more blocks using a plurality of prediction patterns.
2. The method of clause 1 wherein in each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position.
3. The method of clause 1 further comprising determining a color filter array used in acquiring the image.
4. The method of clause 2 wherein the color filter array is a Bayer filter, a Wichi filter or a Complementary filter.
5. The method of clause 2 wherein the plurality of prediction patterns is selected based on the determined color filter array.
6. The method of clause 1 wherein encoding the one or more blocks includes computing prediction values for each pixel in a block of the one or more blocks using one or more prediction modes.
7. The method of clause 5 wherein the prediction modes include at least one of:
   a. DC;
   b. RightRightUp;
   c. RightUp;
   d. RightUpUp;
   e. Up;
   f. LeftUpUp;
   g. LeftUp;
   h. LeftLeftUp; and
   i. Left.
8. The method of clause 1 wherein when prediction from pixels located in the same row but at the left of a current block is not possible, a left pixel in a block of the one or more blocks uses a modified left prediction mode.
9. The method of clause 1 wherein when a block of the one or more blocks is on a boundary of the image, boundary pixels are extended by copying the block to fit the plurality of prediction patterns.
10. The method of clause 1 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.
11. A system for image compression programmed in a controller in a device comprising:
   a. a partitioning module configured for partitioning an image into one or more blocks; and
   b. an encoding module configured for encoding the one or more blocks using a plurality of prediction patterns.
12. The system of clause 11 wherein in each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position.
13. The system of clause 11 further comprising a determining module configured for determining a color filter array used in acquiring the image.
14. The system of clause 13 wherein the color filter array is a Bayer filter, a Wichi filter or a Complementary filter.
15. The system of clause 13 wherein the plurality of prediction patterns is selected based on the determined color filter array.
16. The system of clause 11 wherein encoding the one or more blocks includes computing prediction values for each pixel in a block of the one or more blocks using one or more prediction modes.
17. The system of clause 16 wherein the prediction modes include at least one of:
   a. DC;
   b. RightRightUp;
   c. RightUp;
   d. RightUpUp;
   e. Up;
   f. LeftUpUp;
   g. LeftUp;
   h. LeftLeftUp; and
   i. Left.
18. The system of clause 11 wherein when prediction from pixels located in the same row but at the left of a current block is not possible, a left pixel in a block of the one or more blocks uses a modified left prediction mode.
19. The system of clause 11 wherein when a block of the one or more blocks is on a boundary of the image, boundary pixels are extended by copying the block to fit the plurality of prediction patterns.
20. The system of clause 11 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.
21. A camera device comprising:
   a. a video acquisition component for acquiring a video;
   b. a memory for storing an application, the application for:
      i. partitioning an image into one or more blocks; and
      ii. encoding the one or more blocks using a plurality of prediction patterns; and
   c. a processing component coupled to the memory, the processing component configured for processing the application.
22. The camera device of clause 21 wherein in each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position.
23. The camera device of clause 21 wherein the application is further for determining a color filter array used in acquiring the image.
24. The camera device of clause 23 wherein the color filter array is a Bayer filter, a Wichi filter or a Complementary filter.
25. The camera device of clause 23 wherein the plurality of prediction patterns is selected based on the determined color filter array.
26. The camera device of clause 21 wherein encoding the one or more blocks includes computing prediction values for each pixel in a block of the one or more blocks using one or more prediction modes.
27. The camera device of clause 26 wherein the prediction modes include at least one of:
   a. DC;
   b. RightRightUp;
   c. RightUp;
   d. RightUpUp;
   e. Up;
   f. LeftUpUp;
   g. LeftUp;
   h. LeftLeftUp; and
   i. Left.
28. The camera device of clause 21 wherein when prediction from pixels located in the same row but at the left of a current block is not possible, a left pixel in a block of the one or more blocks uses a modified left prediction mode.
29. The camera device of clause 21 wherein when a block of the one or more blocks is on a boundary of the image, boundary pixels are extended by copying the block to fit the plurality of prediction patterns.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of intra prediction for compression programmed in a controller of a device comprising:
a. partitioning an image into one or more blocks; and
b. encoding the one or more blocks using a plurality of prediction patterns.

2. The method of claim 1 wherein in each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position.

3. The method of claim 1 further comprising determining a color filter array used in acquiring the image.

4. The method of claim 2 wherein the color filter array is a Bayer filter, a Wichi filter or a Complementary filter.

5. The method of claim 2 wherein the plurality of prediction patterns is selected based on the determined color filter array.

6. The method of claim 1 wherein encoding the one or more blocks includes computing prediction values for each pixel in a block of the one or more blocks using one or more prediction modes.

7. The method of claim 5 wherein the prediction modes include at least one of:
a. DC;
b. RightRightUp;
c. RightUp;
d. RightUpUp;
e. Up;
f. LeftUpUp;
g. LeftUp;
h. LeftLeftUp; and
i. Left.

8. The method of claim 1 wherein when prediction from pixels located in the same row but at the left of a current block is not possible, a left pixel in a block of the one or more blocks uses a modified left prediction mode.

9. The method of claim 1 wherein when a block of the one or more blocks is on a boundary of the image, boundary pixels are extended by copying the block to fit the plurality of prediction patterns.

10. The method of claim 1 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

11. A system for image compression programmed in a controller in a device comprising:
a. a partitioning module configured for partitioning an image into one or more blocks; and
b. an encoding module configured for encoding the one or more blocks using a plurality of prediction patterns.

12. The system of claim 11 wherein in each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position.

13. The system of claim 11 further comprising a determining module configured for determining a color filter array used in acquiring the image.

14. The system of claim 13 wherein the color filter array is a Bayer filter, a Wichi filter or a Complementary filter.

15. The system of claim 13 wherein the plurality of prediction patterns is selected based on the determined color filter array.

16. The system of claim 11 wherein encoding the one or more blocks includes computing prediction values for each pixel in a block of the one or more blocks using one or more prediction modes.

17. The system of claim 16 wherein the prediction modes include at least one of:
a. DC;
b. RightRightUp;
c. RightUp;
d. RightUpUp;
e. Up;
f. LeftUpUp;
g. LeftUp;
h. LeftLeftUp; and
i. Left.

18. The system of claim 11 wherein when prediction from pixels located in the same row but at the left of a current block is not possible, a left pixel in a block of the one or more blocks uses a modified left prediction mode.

19. The system of claim 11 wherein when a block of the one or more blocks is on a boundary of the image, boundary pixels are extended by copying the block to fit the plurality of prediction patterns.

20. The system of claim 11 wherein the device comprises a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television or a home entertainment system.

21. A camera device comprising:
a. a video acquisition component for acquiring a video;
b. a memory for storing an application, the application for:
i. partitioning an image into one or more blocks; and
ii. encoding the one or more blocks using a plurality of prediction patterns; and
c. a processing component coupled to the memory, the processing component configured for processing the application.

22. The camera device of claim 21 wherein in each block of the one or more blocks, all pixels in the block use one of nine possible prediction patterns, wherein a prediction pattern is the same for all the pixels in the block but is able to change from the block to another block by signaling, and in each block, an order of processing of the pixels is in raster scan order, from left to right and from top to bottom, wherein prediction for each color component is performed using samples only from the same color component but at a different position.

23. The camera device of claim 21 wherein the application is further for determining a color filter array used in acquiring the image.

24. The camera device of claim 23 wherein the color filter array is a Bayer filter, a Wichi filter or a Complementary filter.

25. The camera device of claim 23 wherein the plurality of prediction patterns is selected based on the determined color filter array.

26. The camera device of claim 21 wherein encoding the one or more blocks includes computing prediction values for each pixel in a block of the one or more blocks using one or more prediction modes.

27. The camera device of claim 26 wherein the prediction modes include at least one of:
a. DC;
b. RightRightUp;
c. RightUp;
d. RightUpUp;
e. Up;
f. LeftUpUp;
g. LeftUp;
h. LeftLeftUp; and
i. Left.

28. The camera device of claim 21 wherein when prediction from pixels located in the same row but at the left of a current block is not possible, a left pixel in a block of the one or more blocks uses a modified left prediction mode.

29. The camera device of claim 21 wherein when a block of the one or more blocks is on a boundary of the image, boundary pixels are extended by copying the block to fit the plurality of prediction patterns.
